(19) United States
(12) Patent Application Publication
(10) Pub. No.: US 2007/0261291 A1
(43) Pub. Date: Nov. 15, 2007

(54) Clear catch fishing hooks

(76) Inventor: Vernon Magazzu, Spring Valley, CA (US)

Correspondence Address: Galasso & Associates, LP, P.O. Box 26503, Austin, TX, 78755-0503, US

(21) Appl. No.: 11/432,702

(22) Filed: May 10, 2006

(51) Int. Cl. A01K 83/00

(52) U.S. Cl. 43/43.16; 43/44.82

(57) ABSTRACT

Clear Catch Fishing Hooks are transparent fishing hooks ideally made of plastic. Clear Catch Fishing Hooks operate in the same manner as traditional fishing hooks. They can be attached to a line and baited and/or attached to a lure. Due to their transparent construction, they are more difficult for a fish to identify and, consequently, more likely to allow a fishermen to catch fish.

### CROSS REFERENCE TO RELATED APPLICATIONS

This Non-Provisional Patent Application does not claim priority to any United States provisional patent application or any foreign patent applications.

### FIELD OF THE DISCLOSURE

The disclosures made herein relate generally to the fishing tackle and accessories industry. The invention discussed herein is in the general classification of fishing hooks.

### BACKGROUND

Fishing is a popular activity enjoyed by millions of people worldwide. In addition to being a recreational activity, fishing is one of the largest food acquiring industries and has been around for centuries.

Generally, the basic items needed for fishing are a hook, a line, and a sinker. However, most anglers have a variety of fishing rods, reels, line types, hooks, floats, and artificial lures. Most of these items will be stored in the angler's tackle box. Unfortunately, many anglers and recreational fishermen become frustrated when they are unsuccessful using these conventional items to catch fish. The problem often is a simple one. If the fish can see the hook in the water, they become wary and are disinclined to approach the fishing hook.

Hence, there is a need in the art for an easy to use, affordable and transparent fishing hook that will be difficult for fish to locate.

### SUMMARY OF THE DISCLOSURE

Clear Catch Fishing Hooks are transparent fishing hooks. They are most often made of plastic and function in the same manner as a traditional fishing hook. They can be attached to a line and baited and/or attached to a lure.

The principal object of this invention is to provide an easy to use, transparent fishing hook.

Another object of this invention is to provide an affordable fishing hook that will be difficult for fish to see in the water.

Yet another object of this invention is to provide a transparent fishing hook that is easily stored with other fishing equipment in a tackle box.

### BRIEF DESCRIPTION OF THE DRAWINGS

FIG. 1 depicts a perspective view of the preferred embodiment of the invention.

FIG. 2 depicts a perspective view of another embodiment of the present invention.

FIG. 3 depicts a perspective view of one embodiment of the present invention attached to a lure.

### DETAILED DESCRIPTION OF THE DRAWINGS

Clear Catch Fishing Hooks are transparent fishing hooks. These hooks are ideally made of environmentally friendly plastic. A lure can also be attached to the transparent hook as with any traditional fishing hook.

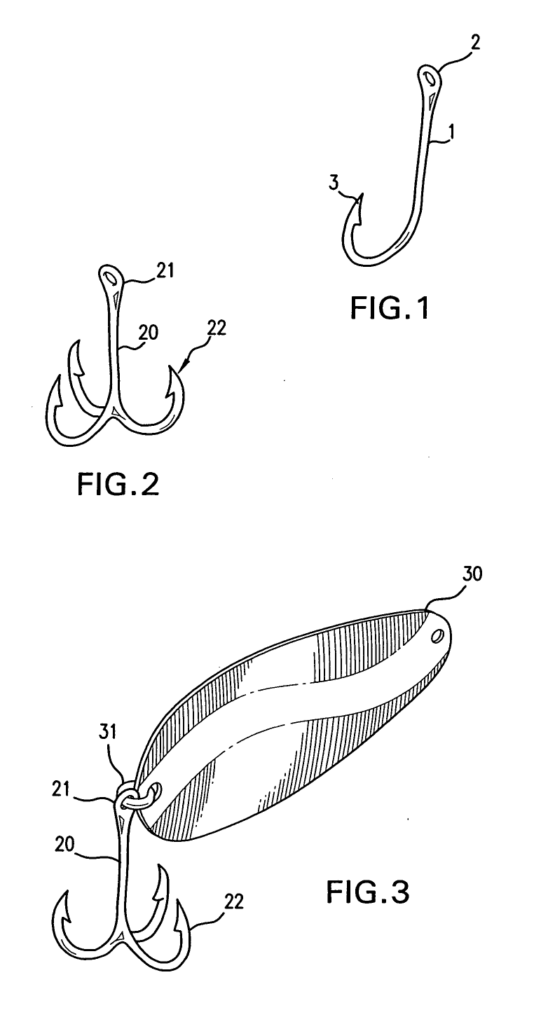

FIG. 1 depicts the preferred embodiment of the invention. It consists of a single, u-shaped fishing hook 1. The loop end 2 of the fishing hook 1 can be attached to a line (not pictured) or lure (not pictured). The hook 1 has a barbed end 3 opposite the loop end 2 for catching fish. The hook 1 is transparent and made of thermoplastic.

FIG. 2 depicts another embodiment of the present invention. It consists of a treble fishing hook 20 with a loop end 21 to attach to a line (not pictured) or lure (not pictured) and three barbed ends 22 used for catching fish. The hook 20 is again transparent and made of thermoplastic.

FIG. 3 depicts the fishing hook of FIG. 2 attached to a lure 30. The lure 30 is attached to the hook 20 using a standard ring 31 that attaches to the loop end 21. The lure 30 entices fish to approach the treble fishing hook 20, increasing the chances the fish come into contact with the barbed ends 22 of the treble fishing hook 20.

Clear Catch Fishing Hooks operate in the same manner as traditional fishing hooks. They can be attached to a line and baited and/or attached to a lure. Due to their transparency, they are more difficult for a fish to identify. Consequently, fish are more likely to approach the hook and become impaled on the barbed end or ends of the hook.

The components of Clear Catch Fishing Hooks may vary widely but will likely utilize metal and plastic components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Clear Catch Fishing Hooks can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

The size of Clear Catch Fishing Hooks may vary widely. They can be made in all standard fishing hook sizes. The plastic used in making the fishing hook will ideally be made of an environmentally friendly material.

It should be obvious that any transparent, clear or translucent material could be used to make the hooks of the present invention. “Transparent” includes any material that allows at least some light to pass through it, including translucent materials. Any colored translucent material also will satisfy the spirit of this invention. In particular, pigmented hooks that match the color of the surrounding water could also be utilized. It should also be obvious that a “loop end” is any end that will allow attachment to a fishing line or lure. A magnet attached to the hook could also be used in some embodiments of the current invention.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A fishing device comprising:
(a) a transparent hook;
(b) a barbed end on the transparent hook; and
(c) a looped end on the transparent hook opposite the barbed end.

2. (canceled)

3. The fishing device of claim 1 wherein the transparent hook is made of plastic.

4. The fishing device of claim 1 wherein the transparent hook is u-shaped.

5. (canceled)

6. (canceled)

7. A fishing device comprising:
(a) a transparent hook;
(b) a plurality of barbed ends on the transparent hook; and
(c) a looped end on the transparent hook opposite the barbed end.

8. (canceled)
